(19) United States
(12) Patent Application Publication
(10) Pub. No.: US 2011/0167065 A1
(43) Pub. Date: Jul. 7, 2011

(54) DATA GENERATING APPARATUS, INFORMATION PROCESSING APPARATUS, DATA GENERATING METHOD, INFORMATION PROCESSING METHOD, DATA GENERATING PROGRAM INFORMATION PROCESSING PROGRAM AND RECORDING MEDIUM

(75) Inventors: Shunsaku Toyoda, Toshimaku (JP); Takashi Hanyuda, Kawagoe (JP); Takashi Hashimoto, Yokohama (JP); Ippei Nambata, Fujimi (JP); Hajime Adachi, Tsurugashima (JP)

(73) Assignees: Pioneer Corporation, Kanagawa (JP); Increment P Corporation, Kanagawa (JP)

(21) Appl. No.: 12/997,672

(22) PCT Filed: Jun. 17, 2008
(86) PCT No.: PCT/JP2008/061062

§ 371 Date: Feb. 9, 2011

(51) Int. Cl. G06F 17/30

(52) U.S. Cl. 707/737; 707/E17.046

(57) ABSTRACT

A data generating apparatus includes an acquiring unit that acquires text data (name data) related to a name associated with position information; a classifying unit that using the acquired position data, classifies the name data according to given regions; an integrating unit that integrates neighboring regions such that the total data size of the name data included in regions to be integrated does not exceed a predetermined given data size; a storage unit that groups the name data according to integrated regions and stores the grouped name data as a name dictionary to be used in both a facility search process and a map display process; and an extracting unit that from the classified name data, extracts the name data common to regions of a given number or more, where the storage unit groups and stores the common name data as a common name dictionary different from the name dictionary.

### TECHNICAL FIELD

The present invention relates to a data generating apparatus, an information processing apparatus, a data generating method, an information processing method, a data generating program, an information processing program, and a recording medium. However, the invention is not limited to the data generating apparatus, the information processing apparatus, the data generating method, the information processing method, the data generating program, the information processing program, and the recording medium above.

### BACKGROUND ART

Conventionally, information processing apparatuses such as personal navigation devices (PNDs), cellular telephones and personal digital assistants (PDAs) have functions of displaying map screens and of searching for facilities. When a map screen is displayed, text data (name data) correlated with road link data is displayed superimposed on drawing data for depicting landforms. Further, when a facility search is performed, the name data is displayed as a search result.

To display map screens and perform facility searches in this manner, name data including road names must be stored in advance. For example, a technology is known that separately stores name data for displaying a map screen and name data for facility searches and in the respective processing of the name data, reads out the separately stored name data (see, for example, Patent Document 1).
Patent Document 1: Japanese Patent Application Laid-Open Publication No. 2006-003286

### DISCLOSURE OF INVENTION

### Problem to be Solved by the Invention

However, one problem with the technology recited in Patent Document 1, is for example, since the name data for displaying map screens and for searching for facilities are stored separately, i.e., overlapping name data is stored, the amount of data stored is significant, inviting a drop in the performance of the information processing apparatus.

### Means for Solving Problem

To solve the problems above and achieve an object, a data generating apparatus according to the invention of claim 1 an acquiring unit that acquires text data (name data) related to a name associated with position information; a classifying unit that using the position data associated with the name data acquired by the acquiring unit, classifies the name data according to given regions; an integrating unit that integrates neighboring regions such that the total data size of the name data included in regions to be integrated (integrated regions) does not exceed a given data size that is preliminarily set; and a storage unit that groups the name data according to integrated regions and stores the grouped name data as a name dictionary to be used in both a facility search process and a map display process.

An information processing apparatus according to the invention of claim 6 and executing the map display process and the facility search process, includes a storage unit storing therein the name dictionary and the common name dictionary generated by the data generating apparatus according to any one of claims 1 to 5; a transferring unit that when the map display process or the facility search process is executed, reads from the storage unit and transfers to memory, the name dictionary for the integrated regions including a target region of the process executed; and a display control unit that uses the name dictionary stored to the memory and displays names in the process executed.

A data generating method according to the invention of claim 8 includes acquiring text data (name data) related to a name associated with position information; classifying the name data according to given regions, using the position data associated with the name data acquired by the acquiring unit; integrating neighboring regions such that the total data size of the name data included in regions to be integrated (integrated regions) does not exceed a given data size that is preliminarily set; and grouping the name data according to integrated regions and storing the grouped name data as a name dictionary to be used in both a facility search process and a map display process.

An information processing method according to the invention of claim 9 is performed by an information processing apparatus that executes a map display process and a facility search process and includes a storage unit grouping name data according to integrated regions and storing therein the grouped name data as name dictionaries to be used in both the facility search process and the map display process. The information processing method includes reading from the storage unit and transferring to memory when the map display process or the facility search process is executed, the name dictionary for the integrated regions including the target region of the process executed; and controlling display of names in the process executed by using the name dictionary stored to the memory.

A data generating program according to the invention of claim 10 causes a computer to execute the data generating method according to claim 8.

An information processing program according to the invention of claim 11 causes a computer to execute the data generating method according to claim 9.

A computer-readable recording medium according to the invention of claim 12 stores therein the data generating program according to claim 10 or the information processing program according to claim 11.

### BRIEF DESCRIPTION OF DRAWINGS

FIG. 1 is a block diagram of one example of a functional configuration of a data generating apparatus according to a first embodiment;

FIG. 2 is a flowchart of an example of a data generation process performed by the data generating apparatus according to the first embodiment;

FIG. 3 is a block diagram of one example of a functional configuration of an information processing apparatus according to a second embodiment;

FIG. 4 is a flowchart of an example of information processing performed by the information processing apparatus according to the second embodiment;

FIG. 5 is a block diagram of one example of a hardware configuration of a data generating server according to a first example;

FIG. 6 is a flowchart of an example of a data generating process performed by the data generating server according to the first example;

FIG. 7 depicts an example of a special region and integrated regions;

FIG. 8 depicts a data structure of a common name dictionary;

FIG. 9 depicts a data structure of a city_A name dictionary;

FIG. 10-1 depicts a data structure of a city_C-D-E name dictionary;

FIG. 10-2 depicts another example of a data structure of the common name dictionary;

FIG. 10-3 depicts another example of a data structure of the city_A name dictionary;

FIG. 10-4 depicts a data structure of the city_C-D-E name dictionary;

FIG. 11 is a block diagram of a hardware configuration of a navigation apparatus according to a second example;

FIG. 12 is a flowchart outlining information processing performed by the navigation apparatus according to the second example;

FIG. 13 is a flowchart of one example of information processing performed under a facility search;

FIG. 14 is a flowchart of one example of information processing performed when a map of a specified region is to be displayed; and

FIG. 15 is a flowchart of one example of information processing performed when a map of integrated regions is to be displayed.

### EXPLANATIONS OF LETTERS OR NUMERALS

100 data generating apparatus
101 acquiring unit
102 classifying unit
103 integrating unit
104 storage unit
105 extracting unit
300 information processing apparatus
301 storage unit
302 transferring unit
303 display control unit
304 display unit
500 data generating server
1100 navigation apparatus

### BEST MODE(S) FOR CARRYING OUT THE INVENTION

Preferred embodiments of the data generating apparatus, the information processing apparatus, the data generating method, the information processing method, the data generating program, the information processing program, and the recording medium according to the present invention will be described with reference to the accompanying drawings.

### First Embodiment

### (Functional Configuration of Data Generating Apparatus)

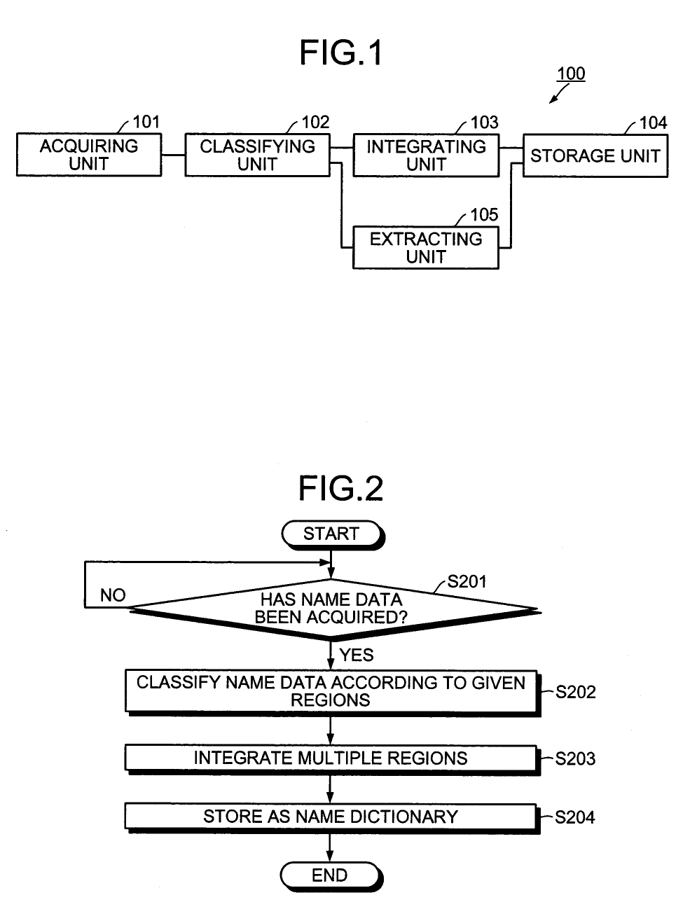

With reference to FIG. 1, a functional configuration of a data generating apparatus according to the first embodiment of the present invention will be described. The data generating apparatus is implemented, for example, by a computer apparatus such as a server, personal computer (PC), etc. FIG. 1 is a block diagram of one example of a functional configuration of the data generating apparatus according to the first embodiment. A data generating apparatus 100 includes an acquiring unit 101, a classifying unit 102, an integrating unit 103, a storage unit 104, and an extracting unit 105.

The acquiring unit 101 acquires text data (hereinafter, “name data”) related to names associated with position information. Position information is information for displaying name data superimposed on drawing data that represents landforms. For example, if the name information is “Kawagoe Kaido”, position information is information associated with drawing data for Kawagoe City and the vicinity through which Kawagoe Kaido (highway) passes.

Although name data is typically text data related to road names, name data includes text data for the names of facilities and geographical features such as rivers and mountains. The means of acquisition by the acquiring unit 101 may be via input from an operation manager of the data generating apparatus 100, via reading from a recording medium, and via receiving transmission from an external server.

The classifying unit 102 uses the position information associated with the name information acquired by the acquiring unit 101 to classify the name data according to given regions. A given region is typically the region of a single city, but may be that of a country, an area such as the Kanto Area and the Tohoku Area, a prefecture, local municipality, etc.

The integrating unit 103 integrates neighboring regions such that the total data size of the name data included in the integrated regions (hereinafter, “integrated regions”) does not exceed a given data size preliminarily set. The storage unit 104 groups the name data according to integrated regions and stores the name data as a name dictionary to be used for both the facility search process and the map display process.

Further, in the first embodiment, the integrating unit 103 may be configured to not integrate a region (hereinafter, “special region”) having name data that is equal to or exceeds the given data size or for which the total data size when integrated with a neighboring region equals or exceeds the given data size.

Specifically, for example, if a region for which the volume of name data is great such as a large urban area or if an integration of neighboring urban areas, such as mid-sized cities, causes the total data size of the name data to become equal to or exceed the given data size, the integrating unit 103 does not integrate such region. Such a large urban region or mid-sized cities are referred to as special regions. In the case of a special region, the storage unit 104 groups and stores the name data for the special region as a name dictionary to be used in both facility search process and in map display process. In other words, the storage unit 104 stores the name data of a special region as an independent name dictionary.

Further, in the first embodiment, the integrating unit 103, may change the given data size according to the storage capacity of the storage unit 104 to integrate regions. Specifically, the greater the capacity of the storage unit 104, the more the integrating unit 103 increases the data size to integrate regions. In addition to the capacity of the storage unit 104, the integrating unit 103 may change the given data size and integrate regions according to the capacity of a storage unit in an information processing apparatus furnished as a user terminal apparatus of the data generating apparatus 100.

Also, in the first embodiment, the extracting unit 105 is an arbitrary component. The extracting unit 105, from among name data classified according to given regions, extracts name data common to a given number of regions or more (hereinafter, “common name data”). Common name data are names commonly used in multiple regions, such as “Main Street” used abroad, “Chuo Dori”, “Kaigan Dori”, and “Odori” used domestically in Japan.

In the configuration including the extracting unit 105, the storage unit 104 groups common name data and stores the grouped common name data as a common name dictionary different from the name dictionaries. In this case, common name data is not stored in the name dictionaries. For example, if name data for “Main Street” in city A exists, the storage unit 104 stores “Main Street” in the common name dictionary without storing “Main Street” to the name dictionary for city A.

In the first embodiment, an output unit, not depicted, may be included. The output unit transmits information in the name dictionary and in the common name dictionary stored by the storage unit 104, to an information processing apparatus used as a user terminal apparatus and records the information to a recording medium for distribution, such as an optical disk.

### (Data Generation Process of Data Generating Apparatus)

Next, with reference to FIG. 2, a data generation process of the data generating apparatus 100 will be described. FIG. 2 is a flowchart of an example of a data generation process performed by the data generating apparatus 100 according to the first embodiment.

As depicted in FIG. 2, the data generating apparatus 100 determines whether the acquiring unit 101 has acquired name data (step S201). The data generating apparatus 100 remains in a standby state until name data had been acquired (step S201: NO). When name data has been acquired (step S201: YES), the classifying unit 102 classifies the name data according to given regions, by using position information associated with the name data (step S202).

The integrating unit 103 integrates regions such that the total data size of the name data included in the integrated regions does not exceed a given data size preliminarily set (step S203), after which the storage unit 104 groups the name data according to integrated regions and stores the grouped name data as a name dictionary to be used in both the facility search process and the map display process (step S204), ending a series of operations.

As described, the data generating apparatus 100 according to the first embodiment integrates regions such that the total data size of the name data included in the integrated regions does not exceed a given data size preliminarily set, groups the name data according to integrated regions, and stores the grouped name data as a name dictionary to be used in both the facility search process and the map display process. Therefore, by not storing overlapping name data, the amount of data stored can be suppressed.

Further, with information processing apparatuses, such as a navigation apparatus using the name dictionary, when map display process is performed, compared to a case where a name dictionary is stored for each region, the number of processes for referencing the name dictionaries decreases by the number of dictionary divisions removed. Thus, rapid processing becomes possible, enabling improved performance of the information processing apparatus.

By not integrating special regions, which have name data that is equal to or exceeds the given data size or for which the total data size when integrated with a neighboring region equals or exceeds the given data size, the data size for each region can be optimized, enabling optimized performance of the information apparatus.

By changing the given data size according to the capacity of the storage unit 104 to integrate regions, integration suitable for the storage capacity can be performed. Therefore, the database can be optimized, enabling optimized performance of the information processing apparatus.

By using text data related to road names as name data, when regions straddling a road are displayed by the map display process of the information processing apparatus, the troublesome referencing of numerous dictionaries stored for each region can be suppressed, enabling improved performance. In other words, when a map display process is performed, compared to a case where a name dictionary is stored for each region, the number of dictionary references decreases by the number of dictionary divisions removed, enabling improved performance.

By extracting from name data classified according to region, common name data common to a given number of regions or more, grouping the extracted common name data, and storing the grouped common name data as a common name dictionary different from the name dictionary, name data common to multiple regions is stored only once in the common dictionary, enabling the data size of the dictionary overall to be suppressed.

### Second Embodiment

### (Functional Configuration of Information Processing Apparatus)

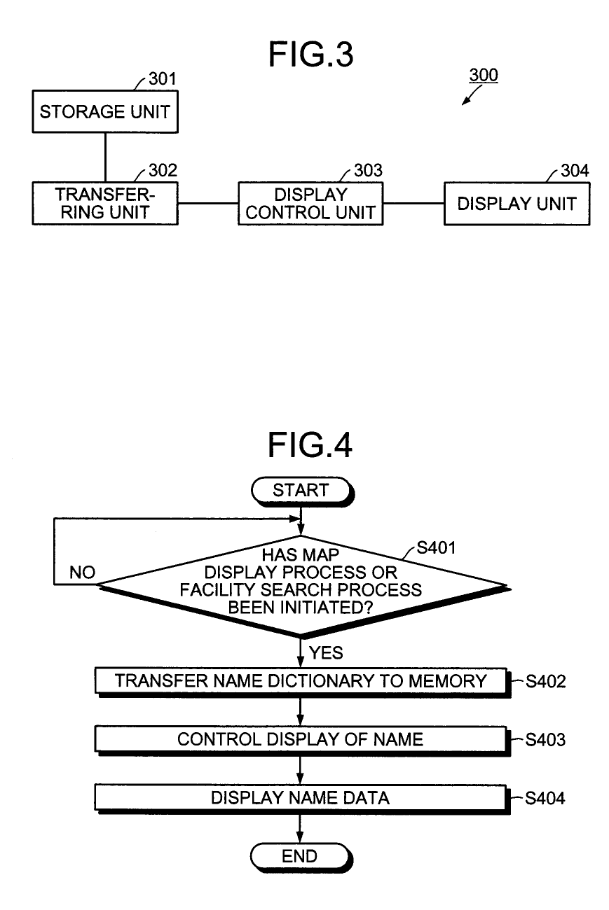

With reference to FIG. 3, a functional configuration of an information processing apparatus according to the second embodiment will be described. The information processing apparatus of the second embodiment uses the name dictionary generated by the data generating apparatus 100 of first embodiment and performs the map display process and the facility search process. The information processing apparatus is implemented by, for example, an electronic device such as a navigation apparatus, a PND, a cellular telephone, a PDA, etc.

FIG. 3 is a block diagram of one example of the functional configuration of the information processing apparatus according to the second embodiment. As depicted in FIG. 3, an information processing apparatus 300 includes a storage unit 301, a transferring unit 302, a display control unit 303, and a display unit 304.

The storage unit 301 stores therein the name dictionary generated by the data generating apparatus 100 according to the first embodiment. To store the name dictionary to the storage unit 301, the means of acquisition of the name dictionary from the data generating apparatus 100 may be via receiving transmission from the data generating apparatus 100 and via reading from a recording medium recorded by the data generating apparatus 100. The storage unit 301 is implemented by a magnetic disk, a flash memory, etc.

The transferring unit 302, when the map display process or the facility search process is performed, reads from the storage unit 301 and transfers to memory, the name dictionary for the integrated regions including the region to be displayed or searched for. The map display process is performed in a map display mode and specifically, for example, when a user selects to have a map screen displayed, when a setting is such that a map screen is to be displayed at startup, etc.

The facility search process is performed in a facility search mode and specifically, when a keyword is input by the user and a search is initiated. When the map display process is performed for a vicinity of the current position, a target region, for example, is the region for the vicinity of the current position and when the facility search process is performed for a given keyword, a target region is the region corresponding to the keyword. The memory is implemented a RAM.

The display control unit 303, using the name dictionary recorded in the memory, displays names in the map display process and the facility search process. The display control unit 303, during the map display process, superimposes name data on drawing data and displays the superimposed data. During the facility search process, the display control unit 303 performs control to superimpose name data on background data (search results) and display the superimposed data; and similar to the map display process, controls to superimpose name data on drawing data for the target region and display the superimposed data. The display unit 304 outputs display of name data under the control of the display control unit 303.

In the second embodiment, besides the name dictionary generated by the data generating apparatus 100 of the first embodiment, the storage unit 301 may store therein the common name dictionary, in which case, the transferring unit 302 reads out from the storage unit 301 and transfers to the memory in advance, the common name dictionary; and when the map display process or the facility search process is performed, reads out from the storage unit 301 and transfers to the memory, the name dictionary for the integrated regions that include the target region. In other words, since the frequency of use of the common name data has the potential of being high, the common name dictionary is set to reside in the memory (RAM). The display control unit 303, using the common name dictionary stored to the memory and the name dictionaries, displays names in the map display process and the facility search process.

### (Information Processing by Information Processing Apparatus)

With reference to FIG. 4, information processing of the information processing apparatus 300 according to the second embodiment will be described. FIG. 4 is a flowchart of an example of information processing performed by the information processing apparatus 300 according to the second embodiment.

As depicted in FIG. 4, the information processing apparatus 300 determines whether processing is to be initiated, processing for either map display or a facility search (step S401). The information processing apparatus 300 remains in a standby state until the map display process or the facility search process is to be initiated (step S401: NO). When the map display process or the facility search process is initiated (step S401: YES), the transferring unit 302 reads out from the storage unit 301 and transfers to the memory, the name dictionary for the integrated regions including the target region of the map display process or the facility search process (step S402).

Subsequently, the display control unit 303, using the name dictionary stored to the memory, performs display control to display names in the map display process or the facility search process (step S403). The display unit 304, under the control of the display control unit 303, displays the name data (step S404), ending a series of operations.

As described, when the map display process or the facility search process is performed, the information processing apparatus 300 transfers the name dictionary for the integrated regions including the target region of the process to the memory and uses the name dictionary stored to the memory to display names in the map display process and the facility search process; therefore, by not storing overlapping name data, the amount of data stored can be suppressed.

When the map display process is performed, compared to a case where a name dictionary is stored for each region, the number of processes for referencing the name dictionaries decreases by the number of dictionary divisions removed. Thus, rapid processing becomes possible, enabling improved performance of the information processing apparatus 300.

By preliminarily transferring a common name dictionary to the memory to store the common name dictionary, when the map display process or the facility search process is performed, the information processing apparatus 300 transfers to the memory, the name dictionary for the integrated regions including the target region of the process and uses the common name dictionary stored in the memory and the name dictionary to display names in the process. Therefore, performance can be improved by setting the common name dictionary, which has a high appearance frequency, to reside in the memory. Further, since name data common to multiple regions is stored only once in the common name dictionary, the data size of the dictionary overall can be suppressed.

### First Example

Herein, a first example of the present invention will be described. In the first example, the data generating apparatus of the invention is implemented by a data generating server. Further, in a second example described hereinafter, the information processing apparatus of the invention is implemented by a navigation apparatus.

### (Hardware Configuration of Data Generating Server)

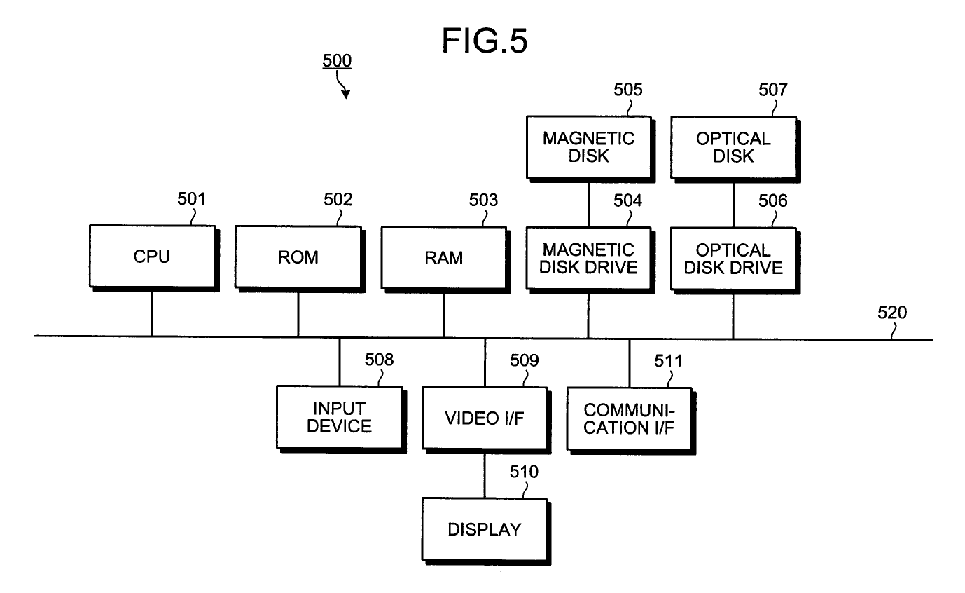

With reference to FIG. 5, a hardware configuration of a data generating server according to the first example will be described. FIG. 5 is a block diagram of one example of a hardware configuration of a data generating server according to the first example.

As depicted in FIG. 5, the data generating server 500 includes a CPU 501, a ROM 502, a RAM 503, a magnetic disk drive 504, a magnetic disk 505, an optical disk drive 506, an optical disk 507, an input device 508, a video interface (I/F) 509, a display 510, and a communication I/F 511, respectively connected by a bus 520.

The CPU 501 governs overall control of the data generating server 500. The ROM 502 and a re-writable, non-volatile memory such as a flash ROM store therein various types of programs such as a boot program, a data generating program, etc. The RAM 503 is used as a work area by the CPU 501.

The data generating program uses position information associated with text data (hereinafter, “name data”) related to names; classifies the name data according to given regions; integrates regions such that the total data size of the name data included in the integrated regions (hereinafter, “integrated regions”) does not exceed a given data size preliminarily set; and generates name dictionaries that are respectively constituted by the name data grouped according to integrated regions and that are used in both the facility search process and the map display process. Name data is primarily text data related to road names (hereinafter, “road name data”).

The data generating program does not integrate a region (hereinafter, “special region”) having name data that is equal to or exceeds a given data size or for which the total data size when integrated with a neighboring region equals or exceeds the given data size.

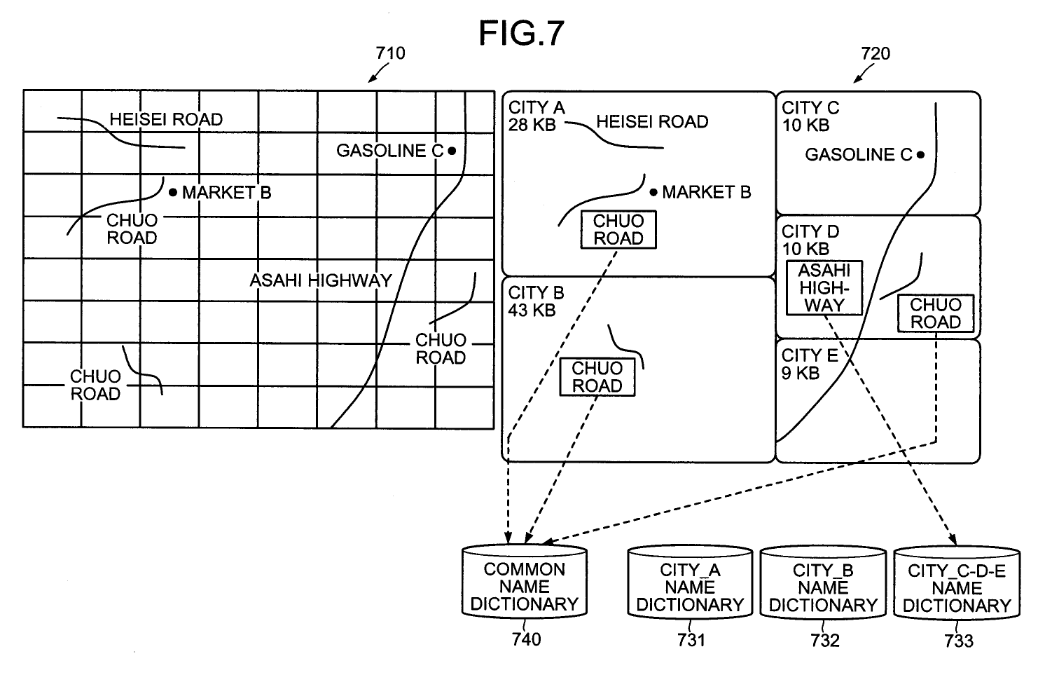

The data generating program extracts name data common to a given number of regions or more (hereinafter, “common name data”); and generates a common name dictionary that is constituted by the common name data and is different from the name dictionaries. The generated name dictionaries and common name dictionary are stored to the magnetic disk 505. The name dictionaries and the common name dictionary will be described in detail hereinafter with reference to FIGS. 7 to 10.

The classifying unit 102, the integrating unit 103, and the extracting unit 105 of the first embodiment are implemented by the CPU 501, i.e., functions of the classifying unit 102, the integrating unit 103, and the extracting unit 105 are implemented by an execution of the data generating program by the CPU 501.

The magnetic disk drive 504, under the control of the CPU 501, controls the reading and the writing of data with respect to the magnetic disk 505. The magnetic disk 505 stores data written thereto under the control of the magnetic disk drive 504. A hard disk (HD) or flexible disk (FD) can be used as the magnetic disk 505. The magnetic disk 505 stores therein the name dictionaries and the common name dictionary output under the CPU 501. The storage unit 104 of the first embodiment is implemented by the magnetic disk 505.

The optical disk drive 506, under the control of the CPU 501, controls the reading and the writing of data with respect to the optical disk 507. The optical disk 507 is a removable recording medium from which data is read out under the control of the optical disk drive 506. The optical disk 507 may further be used as a removable, writable recording medium. Besides the optical disk 507, an MO, memory card, etc. may be employed as a removable recording medium. Under the control of the optical disk drive 506, the name dictionaries and the common name dictionary stored in the magnetic disk 505 may be recorded to the optical disk 507 for distribution.

The input device 508 may be a remote controller having keys for inputting letters, numerals, and various instructions, a keyboard, a mouse, a touch panel, etc. Through user operation, the input device 508 receives input of name data associated with position information. The acquiring unit 101 of the first embodiment is implemented by the input device 508.

The video I/F 509 is connected to the display 510. The video I/F 509, specifically, for example, includes a graphic controller that governs overall control of the display 510, a buffer memory such as VRAM (Video RAM) that temporarily stores immediately displayable image information, and a control IC that controls the display 510.

The communication I/F 511 is wirelessly connected to a communication network and functions as an interface between the communication network and the CPU 501. Although in the present example, name data is acquired via input to the input device 508, transmission from an external device may be received via the communication I/F 511 to acquire the name data, or the name data may be read out from the optical disk 507. Furthermore, under the control of the CPU 501, the communication I/F 511 may transmit the name dictionary and the common name dictionary stored in the magnetic disk 505 to an information processing apparatus such as the navigation apparatus described hereinafter.

Functions of the acquiring unit 101, the classifying unit 102, the integrating unit 103, the storage unit 104, and the extracting unit 105 of the data generating apparatus 100 depicted in FIG. 1 are implemented by an execution of a given program by the CPU 501 to control components of the data generating server 500, the programs used by the CPU 501 being stored in the ROM 502, the RAM 503, the magnetic disk 505, the optical disk 507, etc. of the data generating server 500.

In other words, by the CPU 501 executing the data generating program stored on a recording medium such as the ROM 502, the data generating server 500 of the present example executes, according to the data generating process depicted in FIG. 2, the functions of the data generating apparatus 100 depicted in FIG. 1.

### (Data Generating Process Performed by Data Generating Server)

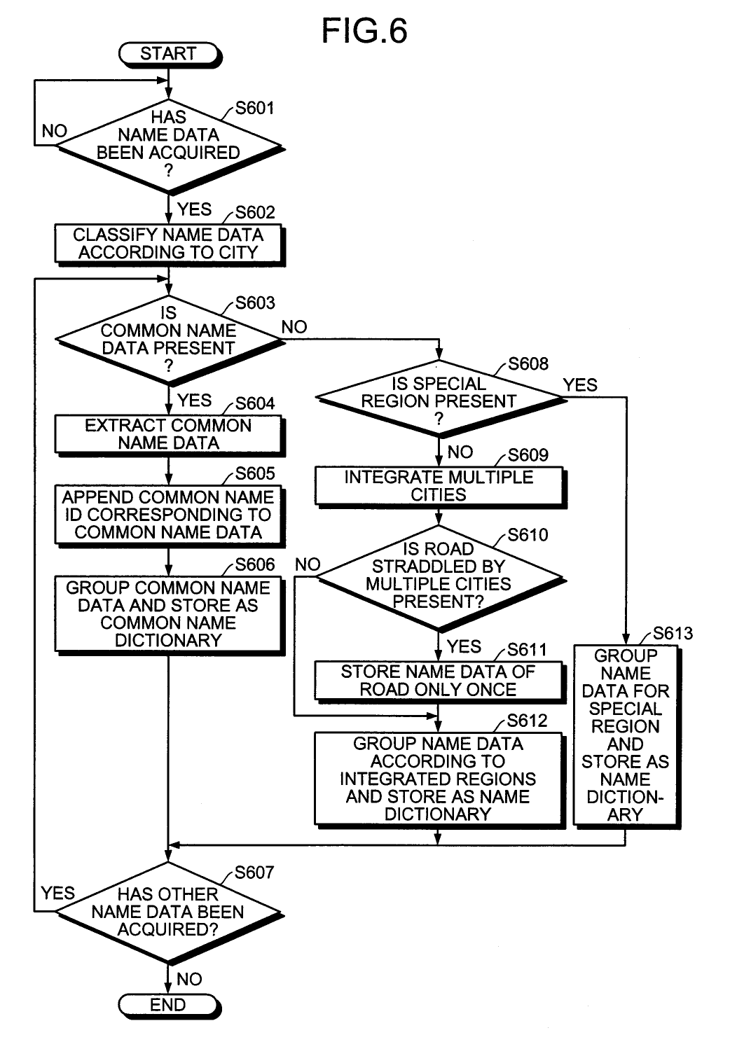

With reference to FIG. 6, an example of a data generating process performed by the data generating server 500 according to the first example will be described. FIG. 6 is a flowchart of an example of a data generating process performed by the data generating server 500 according to the first example.

As depicted in FIG. 6, the CPU 501 of the data generating server 500 determines whether name data has been acquired by, for example, input to the input device 508 (step S601). The CPU 501 remains in a standby state until name data is acquired (step S601: NO). When name data has been acquired (step S601: YES), the CPU 501 classifies the name data according to city (step S602).

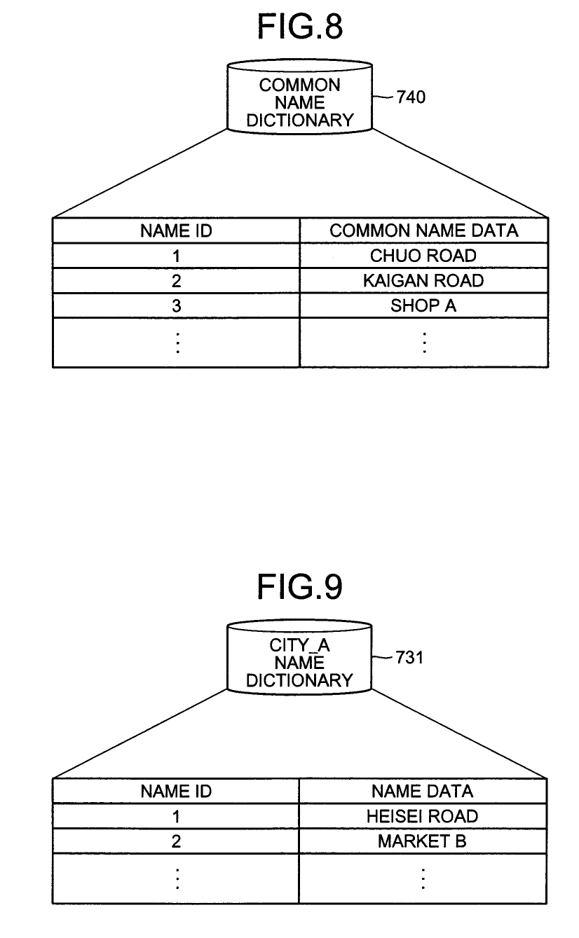

From among the classified name data, the CPU 501 determines whether common name data that is common to regions of a given number or more is present (step S603). If common name data is present (step S603: YES), the CPU 501 extracts the common name data (step S604). Subsequently, the CPU 501 respectively appends common name IDs to the common name data (step S605). The common name data is described in detail hereinafter with reference to FIGS. 7 and 8.

Under the control of the CPU 501, the common name data is collectively stored to the magnetic disk 505 as a common name dictionary (step S606). The CPU 501 determines whether other name data has been acquired (step S607). If other name data has not been acquired (step S607: NO), a series of processes ends. On the other hand, if other name data has been acquired (step S607: YES), the flow returns to step S603.

At step S603, if the CPU 501 determines that common name data is not present (step S603: NO), the CPU 501 determines whether a special region is present (step S608). Although detailed description will be given with reference to FIGS. 7 and 9, a special region is a region having name data that is equal to or exceeds a given data size (e.g., 30 KB) or a region that when integrated with a neighboring region, the total data size of the name data equals or exceeds the given data size.

If a special region is not present (step S608: NO), the CPU 501 integrates neighboring cities (step S609). The CPU 501 determines whether a road straddled by the cities is present (step S610). If a road straddled by the cities is present (step S610: YES), the CPU 501 stores the name data of the road only once (step S611).

The name data for a road straddled by multiple cities being stored only once means that road name data for a road straddled by multiple cities is not stored multiple times according to city. In other words, for example, if a first city and a second city are integrated and a road straddled by the first city and the second city (e.g., road X) is present, the road name data “road X” is not stored for each of the cities A and B, but rather “road X” text data is stored once to suppress data size.

After step S611, under the control of the CPU 501, name data is grouped according to integrated regions and stored to the magnetic disk 505 as name dictionaries (step S612), and the flow proceeds to step S607. At step S610, if it is determined that a road straddled by the cities is not present (step S610: NO), storage of the name dictionaries at step S612 is performed.

Further, at step S608, if it is determined that a special region is present (step S608: YES), name data for the special region is grouped and stored as a name dictionary without integration of the cities (step S613), and the flow proceeds to step S607.

### (Example of Special Region and Integrated Regions)

With reference to FIG. 7, an example of a special region and integrated regions will be described. FIG. 7 depicts an example of a special region and integrated regions.

In FIG. 7, reference numeral 710 depicts map data for multiple cities. Reference numeral 720 depicts separated data, which is the map data 710 separated according to city. The map data 710 includes, for example, a road named “Heiwa Road”, 3 different roads each named “Chuo Road”, a highway name “Asahi Highway”, and facilities named “market B” and “gasoline C”. The map data 710 is configured by gridded blocks (mesh).

The separated data 720 depicts the map data 710 separated according to city A to E. The size of the name data for the cities A to E respectively is 28 KB, 43 KB, 10 KB, 10 KB, and 9 KB. In the present example, the upper limit of the name dictionary to be stored for each of the cities is 30 KB. Cities that exceed this 30 KB limit (city B) and regions that when combined with other regions, exceed the KB limit (city A) are special regions that are not to be integrated and an independent name dictionary is stored for each special region.

In other words for city A, name data is stored as a city_A name dictionary 731 and name data is stored as a city_B name dictionary 732. In the present example, although the upper limit of the name dictionaries to be stored is 30 KB, the value may be changed according to, for example, the storage capacity of the magnetic disk 505 or the storage capacity of the storage unit such as a magnetic disk furnished in an information processing apparatus such as the navigation apparatus described hereinafter.

Meanwhile, if cities C to E are integrated, the total data size is 29 KB and thus, these cities have the potential to be integrated regions. Other words, for cities C to E, a city_C-D-E name dictionary 733 is stored.

For cities A, B, and D, “Chuo Road” is common name data, i.e., name data common to regions of a given number or more. The common name data “Chuo Road” is stored in a common name dictionary 740 different from the city_A name dictionary 731, the city_B name dictionary 732, and the city_C-D-E name dictionary 733. The common name dictionary 740 is appended with dictionary number “0”; the city_A name dictionary 731 is appended with dictionary number “1”; the city_B name dictionary 732 is appended with dictionary number “2”; and the city_C-D-E name dictionary 733 is appended with dictionary number “3”.

To each of the “Chuo Road” links in the drawing data (parcel data) for cities A, B, and D, the dictionary number “0” of the common name dictionary 740 and the name ID “1” are set, whereby it becomes possible to the read in text data for “Chuo Road” appearing when a map is displayed or during a facility search.

Further, name data is present for “Asahi Highway”, which is straddled by cities C, D, and E. As also described with reference to FIG. 6, in the present embodiment, the name data for “Asahi Highway” is not stored for each of the cities C, D, and E, i.e., is not stored in the city_C-D-E name dictionary 733 three times nor stored a number of times corresponding to the number of mesh portions in which “Asahi Highway” is depicted. In other words, the name data for “Asahi Highway” is stored once for cities C, D, and E collectively.

In this case, to each of the “Asahi Highway” links in the drawing data for the cities C, D, and E, the dictionary number “3” of the city_C-D-E name dictionary 733 and the name ID “1” in the city_C-D-E name dictionary 733 are set, whereby it becomes possible to the read in text data for “Asahi Highway” appearing when a map is displayed or during a facility search.

Similarly, without limitation to a road such as “Asahi Highway” straddled by the cities C, D, and E, for the name of a geographical feature such as a beach or mountain straddled by the cities C, D, and E, only the name data is stored and to the geographical feature in drawing data for the cities C, D, and E, the dictionary number and the name ID can be set.

### (Data Structure of Common Name Dictionary)

With reference to FIG. 8, a data structure of the common name dictionary 740 will be described. FIG. 8 depicts a data structure of the common name dictionary 740. As depicted in FIG. 8, the common name dictionary 740 stores therein name IDs and common name data. Specifically, the common name dictionary 740 stores common name data correlated respectively with name IDs. For example, the common name ID “1” is correlated with the common name data “Chuo Road” depicted in FIG. 7.

### (Data Structure of City a Name Dictionary)

With reference to FIG. 9, a data structure of the city_A name dictionary 731 will be described. FIG. 9 depicts a data structure of the city_A name dictionary 731. As depicted in FIG. 9, the city_A name dictionary 731 stores therein name IDs and name data. Name data is text data for names, such as “Heiwa Road” and “market B” depicted in FIG. 7.

A name ID is information for identifying name data in city A. The city_A name dictionary 731 does not store therein text data for “Chuo Road”. As described above, to the “Chuo Road” link in the drawing data for city A, the dictionary number “0” of the common name dictionary 740 and the name ID “1” in the common name dictionary 740 are set, whereby it becomes possible to the read in text data for “Chuo Road” appearing when a map is displayed or during a facility search.

Although graphical depiction is omitted concerning the data structure of the city_B name dictionary 732, the data structure of the city_B name dictionary 732 is the same as the data structure of the city_A name dictionary 731, i.e., is constituted by name IDs and name data.

### (Data Structure of City C-D-E Name Dictionary)

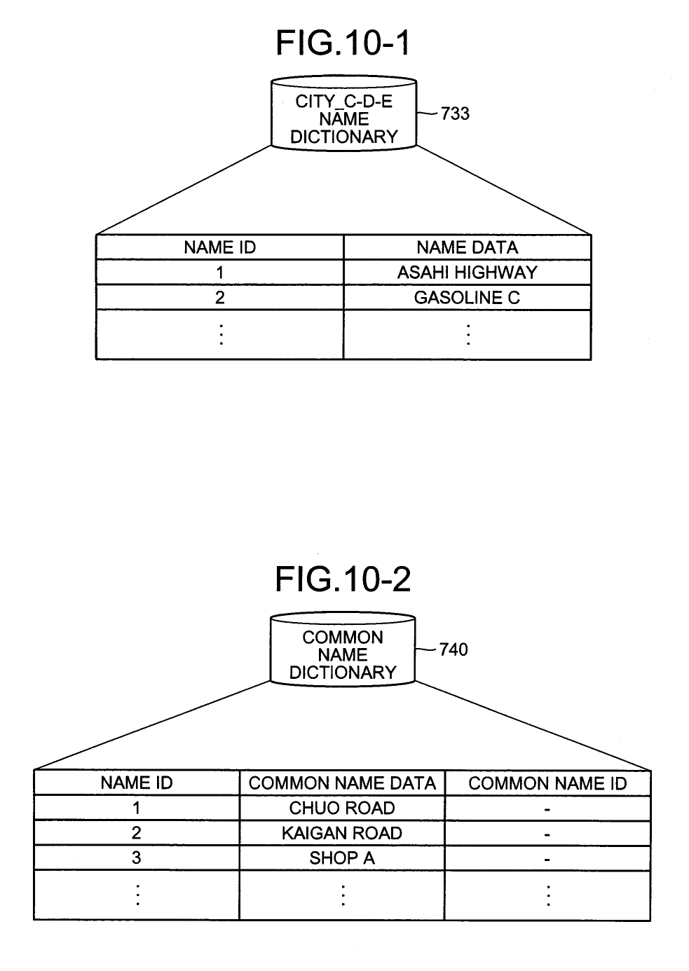

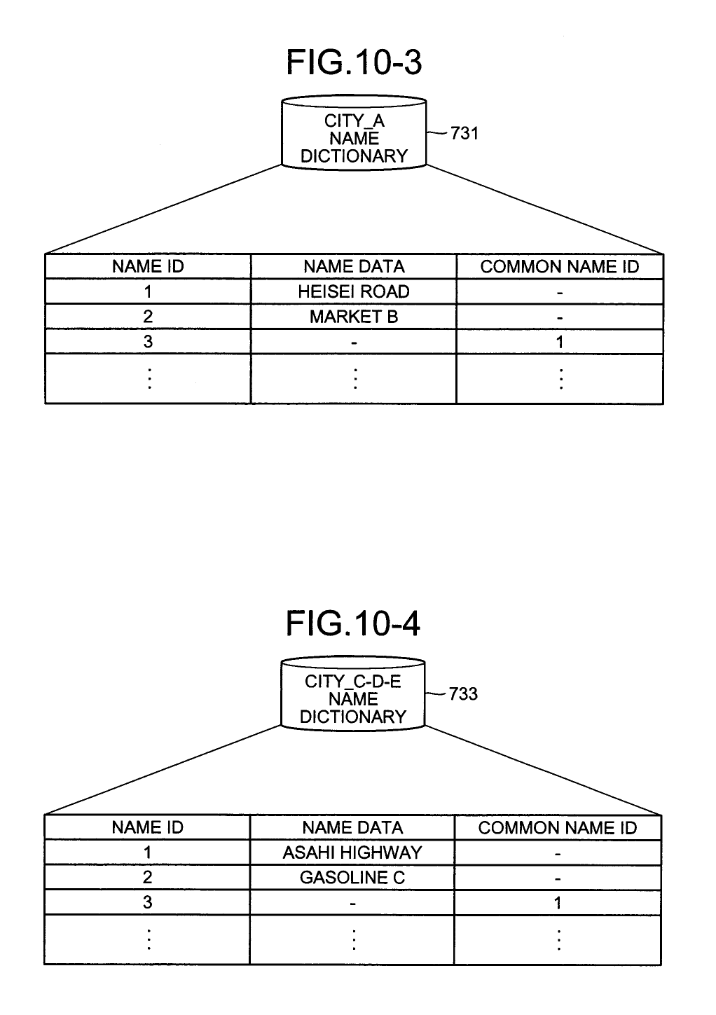

With reference to FIG. 10-1, a data structure of the city_C-D-E name dictionary 733 will be described. FIG. 10-1 depicts a data structure of the city_C-D-E name dictionary 733. As depicted in FIG. 10-1, the city_C-D-E name dictionary 733 includes name IDs and name data. Name data is text data for names, such as “Asahi Highway” and “gasoline C” depicted in FIG. 7.

A name ID is information to identify name data in cities C, D, and E. The city_C-D-E name dictionary 733 stores therein text data for “Asahi Highway” only once. As described above, to the “Asahi Highway” link in the drawing data for the cities C, D, and E, the dictionary number “3” of the city_C-D-E name dictionary 733 and the name ID “1” in the city_C-D-E name dictionary 733 are set, whereby it becomes possible to the read in text data for “Asahi Highway” appearing when a map is displayed or during a facility search.

Similarly to the city_A name dictionary 731, the city_C-D-E name dictionary 733 does not store therein text data for “Chuo Road”. As described above, to the “Chuo Road” link in the drawing data for city D, the dictionary number “0” of the common name dictionary 740 and the name ID “1” in the common name dictionary 740 are set, whereby it becomes possible to the read in text data for “Chuo Road” appearing when a map is displayed or during a facility search.

### (Another Example of Data Structure of Common Name Dictionary)

With reference to FIGS. 10-2 to 10-4, other examples of data structures of the dictionaries will be described. FIG. 10-2 depicts another example of a data structure of the common name dictionary 740. As depicted in FIG. 10-2, the common name dictionary 740 stores therein name IDs, common name data, and common name IDs. For example, the common name ID “1” is correlated with the common name data “Chuo Road” depicted in FIG. 7.

### (Another Example of Data Structure of City_A Name Dictionary)

FIG. 10-3 depicts another example of a data structure of the city_A name dictionary 731. As depicted in FIG. 10-3, the city_A name dictionary 731 stores therein name IDs, name data, and common name IDs. Name data is text data for names, such as “Heiwa Road” and “market B” depicted in FIG. 7.

A name ID is information for identifying name data in city A. Common name IDs correspond to the name IDs in the common name dictionary 740. The common name ID stored corresponding to the name ID “3” is “1”, which corresponds to the name ID stored in the common name dictionary 740 for “Chuo Road”. In other words, the city_A name dictionary 731 does not store therein text data for “Chuo Road”, but rather stores a number as a common name ID.

In this case, to the “Chuo Road” link in the drawing data for city A, the dictionary number “1” of the city_A name dictionary 731 and the name ID “3” (corresponding to the common name ID “1”) in the city_A name dictionary 731 are set, whereby it becomes possible to the read in text data for “Chuo Road” appearing when a map is displayed or during a facility search.

Concerning the data structure of the city_B name dictionary 732, a similar structure is possible, i.e., the data structure includes name IDs, name data, and common name IDs.

### (Another Example of Data Structure of City_C-D-E Name Dictionary)

FIG. 10-4 depicts a data structure of the city_C-D-E name dictionary 733. As depicted in FIG. 10-4, the city_C-D-E name dictionary 733 includes name IDs, name data, and common name IDs. Name data is text data for names, such as “Asahi Highway” and “gasoline C” depicted in FIG. 7.

A name ID is information for identifying name data in cities C, D, and E. Common name IDs correspond to the name IDs in the common name dictionary 740. The common name ID stored corresponding to the name ID “3” is “1”, which corresponds to the name ID stored in the common name dictionary 740 for “Chuo Road”. In other words, the city_C-D-E name dictionary 733 does not store therein text data for “Chuo Road”, but rather stores a number as a common name ID.

In this case, to the “Chuo Road” link in the drawing data for city D, the dictionary number “3” of the city_C-D-E name dictionary 733 and the name ID “3” (corresponding to the common name ID “1”) in the city_C-D-E name dictionary 733 are set, whereby it becomes possible to the read in text data for “Chuo Road” appearing when a map is displayed or during a facility search.

Further, the city_C-D-E name dictionary 733 stores therein text data for “Asahi Highway” only once. In this case, to the “Asahi Highway” link in the drawing data for city D, the dictionary number “3” of the city_C-D-E name dictionary 733 and name ID “1” in the city_C-D-E name dictionary 733 are set, whereby it becomes possible to read in text data for “Asahi Highway” appearing when a map is displayed or during a facility search.

Thus, even with the dictionary data structures depicted in FIGS. 10-2 to 10-4, similarly to the dictionary data structures depicted in FIGS. 8 to 10-1, common name data can be consolidated and regions can be integrated to store name data. The data structures described herein are mere examples and are not limited hereto.

As described, the data generating server 500 according to the first example integrates multiple regions such that the total data size of the name data included in the integrated regions does not exceed a preliminarily set data size of 30 KB, groups the name data according to integrated regions, and stores the grouped name data as a name dictionary (city_C-D-E name dictionary) to be used in both the facility search process and the map display process. Therefore, by not storing overlapping name data, the amount of data stored can be suppressed.

When the map display process is performed in information processing apparatuses such as a navigation apparatus that uses the name dictionary, compared to a case where a name dictionary is stored for each region, the number of processes for referencing the name dictionaries decreases by the number of dictionary divisions removed. Thus, rapid processing becomes possible, enabling improved performance of the information processing apparatus.

Further, by not integrating special regions, which have name data that is equal to or exceeds a given data size of 30 KB or for which the total data size when integrated with a neighboring region equals or exceeds the given data size and by storing the city_A name dictionary and city_B name dictionary independently, the database can be optimized according to region. Therefore, performance of the information processing apparatus can be optimized.

Further, with the present example, the 30 KB data size can be changed according to the capacity of the magnetic disk 505 to integrate multiple regions. This enables integration suitable for the storage capacity to be performed, whereby the database is optimized, enabling improved performance of the information processing apparatus.

Since text data related to road names is used as name data, when a road straddled by multiple regions is displayed by the map display process performed by the information processing apparatus, the troublesome referencing of numerous dictionaries stored for each region can be suppressed, enabling improved performance. In other words, when map display process is performed, compared to a case where a name dictionary is stored for each region, the number of dictionary references decreases by the number of dictionary divisions removed, enabling improved performance.

By extracting from name data classified according to region, common name data common to a given number of regions or more, grouping the extracted common name data, and storing the grouped common name data as the common name dictionary 740 different from the other name dictionaries, name data common to multiple regions is stored only once in the common name dictionary 740, enabling the data size of the dictionary overall to be suppressed.

### Second Example

Hereinafter, a second example of the present invention will be described. In the second example, the information processing apparatus of the present invention is implemented by a navigation apparatus. Furthermore, description given with respect to the first example and applicable in the second example will be omitted for simplicity.

### (Hardware Configuration of Navigation Apparatus)

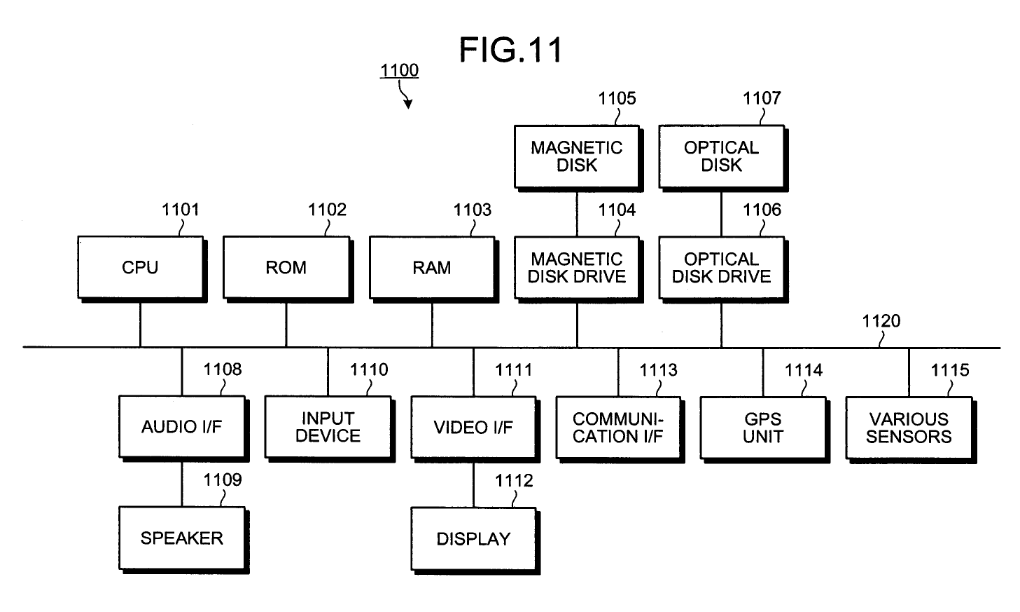

With reference to FIG. 11 a hardware configuration of a navigation apparatus 1100 according to the second example will be described. FIG. 11 is a block diagram of a hardware configuration of the navigation apparatus 1100 according to the second example.

As depicted in FIG. 11, the navigation apparatus 1100 includes a CPU 1101, a ROM 1102, a RAM 1103, a magnetic disk drive 1104, a magnetic disk 1105, an optical disk drive 1106, an optical disk 1107, an audio I/F 1108, a speaker 1109, an input device 1110, a video I/F 1111, a display 1112, a communication I/F 1113, a GPS unit 1114, and various sensors 1115, respectively connected by a bus 1120.

The CPU 1101 governs overall control of the navigation apparatus 1100. The ROM 1102 stores therein various programs such as a boot program, a map display program, a facility search program, an information processing program, etc. The RAM 1103 is used as a work area by the CPU 1101 and stores therein a common name dictionary.

The map displaying program uses map data stored on the magnetic disk 1105 and constituted by drawing data, name data, etc. to, for example, display a map screen for a vicinity of the current position. The facility search program uses name dictionaries and a common name dictionary stored on the magnetic disk 1105 and from the name dictionaries and the common name dictionary, searches for a point that corresponds to a keyword input by a user.

When the map display process is executed by the map displaying program or when the facility search process is executed by the facility search program, the information processing program reads out from the magnetic disk 1105, the name dictionaries generated by the data generating server 500 of the first example, transfers the name dictionaries to the RAM 1103 and using the name dictionaries or the common name dictionary stored in the RAM 1103, outputs the name data in the map display process or the facility search process. The common name dictionary is preliminarily read from the magnetic disk 1105 and stored to the RAM 1103 prior to the execution of the map display process or the facility search process.

The transferring unit 302 and the display control unit 303 of the second embodiment are implemented by the CPU 1101. In other words, functions of the transferring unit 302 and the display control unit 303 are implemented by an execution of the information processing program by the CPU 1101.

The magnetic disk drive 1104, under the control of the CPU 1101, controls the reading and the writing of data with respect to the magnetic disk 1105. The magnetic disk 1105 stores data written thereto under the control of the magnetic disk drive 1104. A hard disk (HD) or flexible disk (FD) can be used as the magnetic disk 1105.

The magnetic disk 1105 stores therein the name dictionaries and the common name dictionary generated by the data generating server 500 of the first example. Further, the magnetic disk 1105 stores therein drawing data (parcel data) constituted by background data representing features such as buildings, rivers, land surfaces, etc. and road-shape data representing the shape of roads and further stores therein background-screen data representing a background screen appearing when a search is performed. For a portable navigation device (PND), data stored to the magnetic disk 1105 is stored to flash memory. The storage unit 301 of the second embodiment is implemented by the magnetic disk 1105.

In the drawing data, to links such as “Chuo Road” and geographical features and having data for names common to multiple cities, the dictionary number of the common name dictionary and the name ID in the common name dictionary are recorded. To road links straddled by the cities and geographical features in drawing data for cities that have been integrated, the dictionary number of the name dictionary and the name ID in the name dictionary are recorded.

The optical disk drive 1106, under the control of the CPU 1101, controls the reading and the writing of data with respect to the optical disk 1107. The optical disk 1107 is a removable recording medium from which data is read out under the control of the optical disk drive 1106. The optical disk 1107 may further be used as a removable, writable recording medium. Besides the optical disk 1107 an MO, memory card, etc. may be employed as a removable recording medium.

In the present example, the optical disk 1107 storing therein the name dictionaries and the common name dictionary generated by the data generating server 500 is used, and by reading out the name dictionaries and the common name dictionary from the optical disk 1107, the name dictionaries and the common name dictionary are stored to the magnetic disk 1105.

The audio I/F 1108 is connected to the speaker 1109 for audio output. The speaker 1109 outputs audio. The input device 1110 may be a remote controller having keys for inputting letters, numerals, and various instructions, a keyboard, a mouse, a touch panel, etc. The input device 1110 may be implemented by any one or combination of the remote controller, keyboard, mouse and touch panel.

The video I/F 1111 is connected to the display 1112. The video I/F 1111, specifically, for example, includes a graphic controller that governs overall control of the display 1112, a buffer memory such as VRAM (Video RAM) that temporarily stores immediately displayable image information, and, and a control IC that controls the display 1112 based on image data output from the graphic controller. The display unit 304 of the second embodiment is implemented by the display 1112.

The communication I/F 1113 is wirelessly connected to a network and functions as an interface between the navigation apparatus 1100 and the CPU 1101. The communication I/F 1113 may receive transmission of the name dictionaries and the common name dictionary generated by the data generating server 500. Further, the communication I/F 1113, under the control of the CPU 1101, may transmit to the data generating server 500, information requesting transmission of a name dictionary or the common name dictionary when the name dictionary or the common name dictionary is to be updated.

The GPS unit 1114 receives signals from GPS satellites and outputs information indicative of the current vehicular position. Information output from the GPS unit 1114 includes values that are output from the various sensors 1115 described hereinafter and that are used by the CPU 1101 to compute the current vehicular position. Information indicative of the current position is information specifying one point on map data, such as latitude/longitude and altitude.

The various sensors 1115 include a vehicular speed sensor, an acceleration sensor, an angular sensor, etc. that output information enabling the behavior of the vehicle to be determined. The values output from the various sensors 1115 are used in the computation of the current vehicular position by the CPU 1101, to estimate changes in the speed and direction, etc.

Functions of the storage unit 301, the transferring unit 302, the display control unit 303, and the display unit 304 of the information processing apparatus 300 depicted in FIG. 3 are implemented by controlling components of the navigation apparatus 1100 by an execution of a program by the CPU 1101 using programs and data recorded to the ROM 1102, the RAM 1103, the magnetic disk 1105, the optical disk 1107, etc. of the navigation apparatus 1100 depicted in FIG. 11.

In other words, the navigation apparatus 1100 of the present example can execute, according to the information processing procedure depicted in FIG. 4, the functions of the information processing apparatus 300 depicted in FIG. 3 through an execution of the information processing program by the CPU 1101, the information processing program being stored to a recording medium such as the ROM 1102.

### (Overview of Information Processing Performed by Navigation Apparatus)

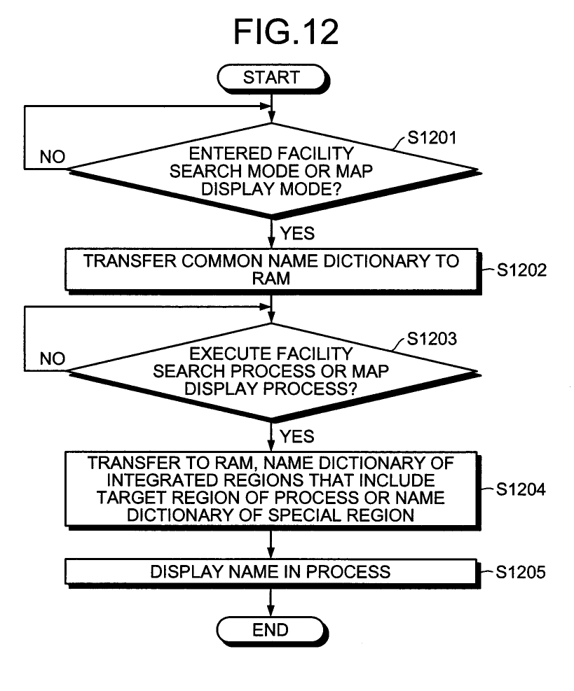

With reference to FIG. 12, an overview of the information processing performed by the navigation apparatus 1100 according to the second example will be described. FIG. 12 is a flowchart outlining the information processing performed by the navigation apparatus 1100 according to the second example.

As depicted in FIG. 12, the CPU 1101 of the navigation apparatus 1100 determines if the navigation apparatus 1100 has entered a facility search mode or a map display mode (step S1201). The CPU 1101 remains in a standby state until the facility search mode or the map display mode is entered (step S1201: NO). When either the facility search mode or the map display mode has been entered (step S1201: YES), the CPU 1101 transfers to the RAM 1103, the common name dictionary stored in the magnetic disk 1105 (step S1202).

Subsequently, the CPU 1101 remains in a standby state until facility search process or map display process is executed (step S1203: NO). When either the facility search process or the map display process is executed (step S1203: YES), the CPU 1101 transfers to the RAM 1103, the name dictionary of the integrated regions that include the target region of the process or the name dictionary of a special region (step S1204), and uses the common name dictionary and the name dictionary stored to the RAM 1103 to display on the display 1112, the name appearing in the process (step S1205), ending a series of operations.

### (Example of Information Processing Performed Under Facility Search)

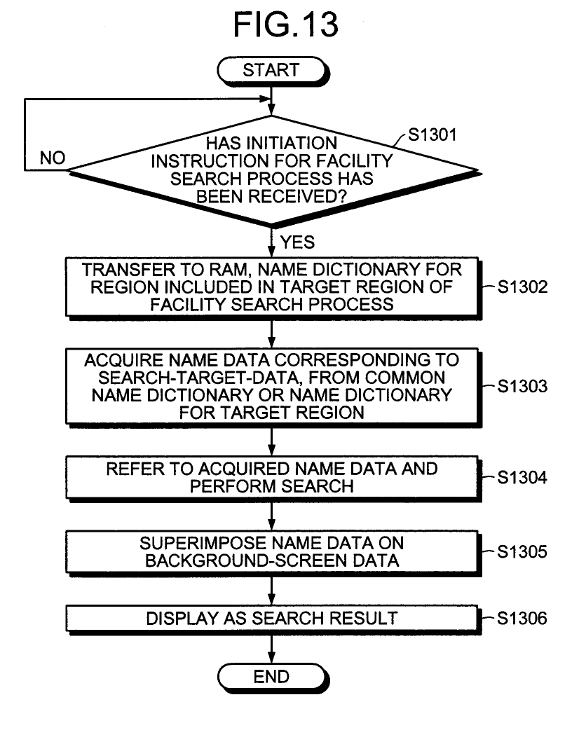

With reference to FIG. 13, one example of information processing performed under a facility search will be described. FIG. 13 is a flowchart of one example of information processing performed under a facility search. In FIG. 13, the common name dictionary is assumed to be preliminarily stored to the RAM 1103.

As depicted in FIG. 13, the CPU 1101 of the navigation apparatus 1100 determines whether a keyword has been entered by the user via the input device 1110 and an initiation instruction for the facility search process has been received (step S1301). The CPU 1101 remains in a standby state until an initiation instruction for the facility search process is received (step S1301: NO). Upon receiving an initiation instruction for the facility search process (step S1301: YES), the CPU 1101 transfers to the RAM 1103, the name dictionary for the region included in the target region (keyword) of the facility search process (step S1302).

Subsequently, the CPU 1101 acquires name data corresponding to the search target data, from the common name dictionary or the name dictionary for the target region (step S1303). The CPU 1101 refers to the name data and performs the search (step S1304). Using results of the common name dictionary and the name dictionary search, the CPU 1101 superimposes the name data (or common name data) on background-screen data (step S1305). Background-screen data is image data for a background when search results are displayed. The CPU 1101 displays the superimposed data as a search result (step S1306), ending a series of operations. When a map of an area indicated by the name data corresponding to the keyword is to be displayed, the name data may be superimposed on drawing data and displayed as a search result.

### (Example of Information Processing Performed for Display of Map of Specified Region)

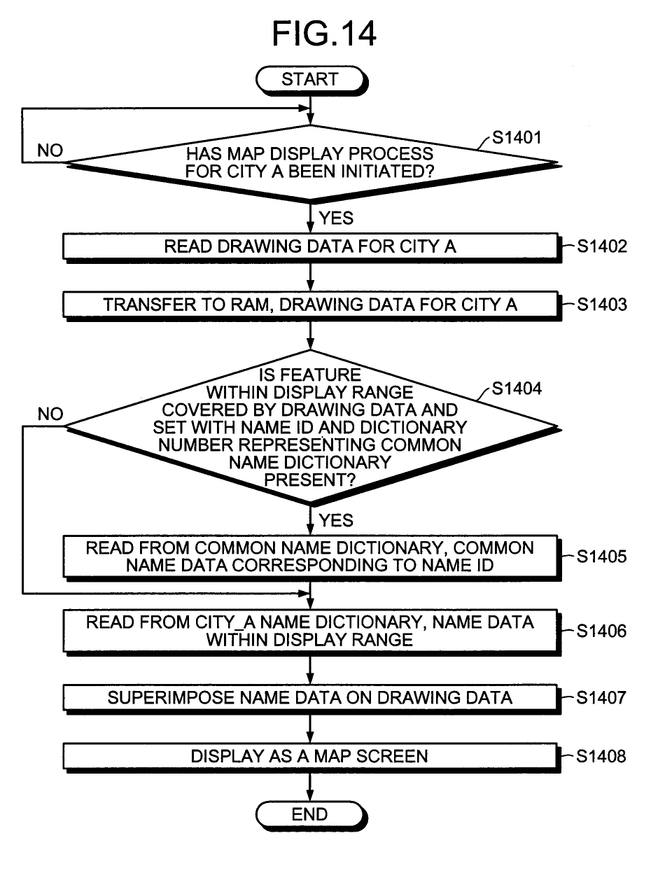

With reference to FIG. 14, one example of information processing performed when a map of a specified region is to be displayed will be described. FIG. 14 is a flowchart of one example of information processing performed when a map of a specified region is to be displayed. In FIG. 14, the common name dictionary is assumed to be preliminarily stored to the RAM 1103. Herein, a specified region includes cities A and B depicted in FIG. 7, and in the description hereinafter, city A will be taken as an example. The data structure of dictionaries stored on the magnetic disk 1105 is identical to that depicted in FIGS. 8 to 10-1.

As depicted in FIG. 14, the CPU 1101 of the navigation apparatus 1100 determines whether the map display process for city A has been initiated (step S1401); the vehicle, for example, is located in a vicinity of city A. The CPU 1101 remains in a standby state until the map display process for city A is initiated (step S1401: NO). When the map display process for city A has been initiated (step S1401: YES), the CPU 1101 reads from the magnetic disk 1105, drawing data for city A (step S1402).

The CPU 1101 transfers the city_A name dictionary (see FIG. 7) to the RAM 1103 (step S1403) and determines whether a feature within a display range covered by the drawing data and set with a name ID and a dictionary number representing the common name dictionary is present (for example, a road such as “Chuo Road” depicted in FIG. 7) (step S1404). If a feature set with a name ID and a dictionary number representing the common name dictionary is present within the display range covered by the drawing data (step S1404: YES), the CPU 1101 reads from the common name dictionary preliminarily stored in the RAM 1103, the common name data corresponding to the name ID (step S1405).

Subsequently, the CPU 1101 reads from the city_A name dictionary, name data within the display range (step S1406). If at step S1404, the CPU 1101 determines that a feature set with a name ID and a dictionary number representing the common name dictionary is not present within the display range covered by the drawing data (step S1404: NO), the flow proceeds to step S1406.

After the process at step S1406, the CPU 1101 superimposes the read name data (or common name data) on the drawing data (step S1407), and displays the superimposed data as a map screen (step S1408), ending a series of operations.

If name dictionaries having the data structure depicted in FIGS. 10-2 to 10-4 are used, at step S1404, “the determination of whether a feature set with a name ID and a dictionary number representing the common name dictionary is present within a display range covered by the drawing data” described is not performed, but rather the CPU 1101 determines “whether a feature set with a dictionary number representing the city_A name dictionary and a name ID having a common name ID is present within the display range covered by the drawing data”. In this case, if a feature set with such a dictionary number and name ID is present, the flow proceeds to step S1405.

### (Example of Information Processing Performed for Display of Map of Integrated Regions)

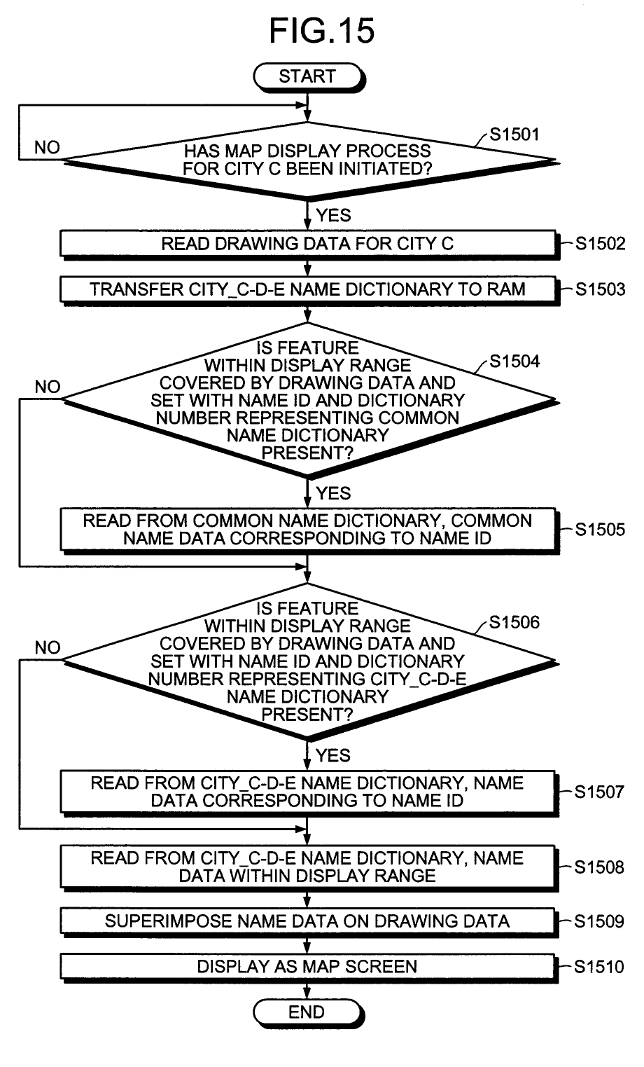

With reference to FIG. 15, one example of information processing performed when a map of integrated regions is to be displayed will be described. FIG. 15 is a flowchart of one example of information processing performed when a map of integrated regions is to be displayed. In FIG. 15, the common name dictionary is assumed to be preliminarily stored to the RAM 1103. Herein, the integrated regions are the cities C, D, and E depicted in FIG. 7 and an example where city C is to be displayed will be described.

As depicted in FIG. 15, the CPU 1101 of the navigation apparatus 1100 determines whether the map display process for city C has been initiated (step S1501); the vehicle, for example, is located in a vicinity of city C. The CPU 1101 remains in a standby state until the map display process for city C is initiated (step S1501: NO). When the map display process for city C has been initiated (step S1501: YES), the CPU 1101 reads out from the magnetic disk 1105, drawing data for city C (step S1502).

The CPU 1101 transfers the city_C-D-E name dictionary (see FIG. 7) to the RAM 1103 (step S1503) and determines whether a feature within a display range covered by the drawing data and set with a name ID and a dictionary number representing the common name dictionary is present (for example, a road such as “Chuo Road” depicted in FIG. 7) (step S1504). If a feature set with a name ID and a dictionary number representing the common name dictionary is present within the display range covered by the drawing data (step S1504: YES), the CPU 1101 reads from the common name dictionary preliminarily stored in the RAM 1103, the common name data corresponding to the name ID (step S1505).

Subsequently, the CPU 1101 determines whether a feature within the display range covered by the drawing data and set with a name ID and a dictionary number representing the city_C-D-E name dictionary (see FIG. 7) is present (for example, a road such as “Asahi Highway” depicted in FIG. 7) (step S1506). If it is determined that a feature set with a name ID and a dictionary number representing the city_C-D-E name dictionary is present within the display range covered by the drawing data (step S1506: YES), the CPU 1101 reads from city_C-D-E name dictionary, the name data corresponding to the name ID (step S1507).

The CPU 1101 reads from city_C-D-E name dictionary, name data within the display range (step S1508); superimposes the read name data (or common name data) on the drawing data (step S1509); and displays the superimposed data as a map screen (step S1510), ending a series of operations.

At step S1504, if the CPU 1101 determines that a feature set with a name ID and a dictionary number representing the common name dictionary is not within the display range covered by the drawing data (step S1504: NO), the flow proceeds to step S1506. Furthermore, at step S1506, if the CPU 1101 determines that a feature set with a name ID and a dictionary number representing the city_C-D-E name dictionary is not present within the display range covered by the drawing data (step S1506: NO), the reading of name data at step S1508 is performed.

If name dictionaries having the data structure depicted in FIGS. 10-2 to 10-4 are used, similar to the explanation given with reference to FIG. 14, the process at step S1504 does not include determining “whether a feature set with a name ID and a dictionary number representing the common name dictionary is present within a display range covered by the drawing data”, but rather includes determining “whether a feature set with dictionary number representing the city_A name dictionary and a name ID having a common name ID is present within the display range covered by the drawing data. In this case, if a feature set with such a dictionary number and name ID is present, the flow proceeds to step S1505.

As described, when the map display process or the facility search process is executed, the navigation apparatus 1100 according to the second example transfers to the memory, the name dictionary for the integrated regions including the target region of the process and uses the name dictionaries stored to the memory to display the name appearing in the map display process or the facility search process. Therefore, overlapping name data is not stored, enabling the amount of data stored to the magnetic disk 1105 to be suppressed.

When the map display process is performed, compared to a case where a name dictionary is stored for each region, the number of processes for referencing the name dictionaries decreases by the number of dictionary divisions removed. Thus, rapid processing becomes possible, enabling improved performance of the navigation apparatus 1100.

The navigation apparatus 1100 according to the second example stores the common name dictionary to the magnetic disk 1105, preliminarily transfers the common name dictionary to the RAM 1103 and when the map display process or the facility search process is executed, transfers the name dictionary for the integrated regions including the target region of the process to the RAM 1103 and uses the common name dictionary and the name dictionaries stored to the RAM 1103 to display names appearing in the map display process or the facility search process.

Therefore, performance can be improved by setting the common name dictionary, which has a high appearance frequency, to reside in the RAM 1103. Further, since name data common to multiple regions is stored only once in the common name dictionary, the data size of the dictionary overall can be suppressed.

As described, through the data generating apparatus, the information processing apparatus, data generating method, information processing method, the data generating program, the information processing program and the recording medium of the present invention, data volume can be suppressed and performance of the facility search process and the map display process can be improved.

The data generating method and the information processing method of the first and the second examples, may be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program may be distributed through a network such as the Internet.

1-12. (canceled)

13. A data generating apparatus comprising:
an acquiring unit that acquires text data (name data) related to a name associated with position information;
a classifying unit that using the position data associated with the name data acquired by the acquiring unit, classifies the name data according to given regions;
an integrating unit that integrates neighboring regions such that the total data size of the name data included in regions to be integrated (integrated regions) does not exceed a given data size that is preliminarily set;
a storage unit that groups the name data according to integrated regions and stores the grouped name data as a name dictionary to be used in both a facility search process and a map display process; and
an extracting unit that from the name data classified according to the given regions, extracts the name data (common name data) that is common to regions of a given number or more, wherein
the storage unit groups and stores the common name data as a common name dictionary different from the name dictionary.

14. The data generating apparatus according to claim 13, wherein
the integrating unit does not integrate a region (special region) for which the name data is equal to or exceeds the given data size or for which the total data size when integrated with a neighboring region equals or exceeds the given data size,
the storage unit groups and stores the name data for a special region as a name dictionary to be used in both the facility search process and the map display process.

15. The data generating apparatus according to claim 13, wherein the integrating unit to integrate regions, changes the given data size according to a storage capacity of the storage unit.

16. The data generating apparatus according to claim 13, wherein the name data is text data related to a road name.

17. An information processing apparatus executing the map display process and the facility search process and comprising:
a storage unit storing therein the name dictionary generated by the data generating apparatus according to claim 13;
a transferring unit that when the map display process or the facility search process is executed, reads from the storage unit and transfers to memory, the name dictionary for the integrated regions including a target region of the process executed; and
a display control unit that uses the name dictionary stored to the memory and displays names in the map display process or the facility search process.

18. The information processing apparatus according to claim 17, wherein
the storage unit stores therein the name dictionary and the common name dictionary generated by the data generating apparatus,
the transferring unit reads from the storage unit and preliminarily transfers to the memory, the common name dictionary and when the map display process or the facility search process is executed, reads from the storage unit and transfers to the memory, the name dictionary for the integrated regions including the target region of the process executed, and
the display control unit uses the name dictionary and the common name dictionary stored to the memory and displays names in the map display process or the facility search process.

19. A data generating method of generating data used in both a map display process and a facility search process, the data generating method comprising:
acquiring acquires text data (name data) related to a name associated with position information;
classifying, using the position data associated with the name data acquired at the acquiring, the name data according to given regions;
integrating neighboring regions such that the total data size of the name data included in regions to be integrated (integrated regions) does not exceed a given data size that is preliminarily set;
grouping the name data according to integrated regions and storing the grouped name data as a name dictionary to be used in both the facility search process and the map display process; and
extracting from the name data classified according to the given regions, the name data (common name data) that is common to regions of a given number or more, wherein
the grouping includes grouping the common name data and the storing includes storing the grouped common name data as a common name dictionary different from the name dictionary.

20. An information processing method of an information processing apparatus that executes the map display process and the facility search process and includes a storage unit storing therein the name dictionary generated by the data generating method according to claim 19, the information processing method comprising:
reading from the storage unit and transferring to memory when the map display process or the facility search process is executed, the name dictionary for the integrated regions including the target region of the process executed; and
controlling display of names in the map display process or the facility search process, by using the name dictionary stored to the memory.

21. A non-transitory computer-readable recording medium storing therein a data generating program causing a computer to execute the data generating method according to claim 19.

22. A non-transitory computer-readable recording medium storing therein an information processing program causing a computer to execute the data generating method according to claim 20.
